(19) United States
(12) Patent Application Publication
(10) Pub. No.: US 2017/0191420 A1
(43) Pub. Date: Jul. 6, 2017

(54) METHOD AND SYSTEM FOR EQUIPMENT COMPARTMENT COOLING

(71) Applicant: General Electric Company, Schenectady, NY (US)

(72) Inventors: Brandon Christopher Clarke, Hebron, KY (US); Daniel Jean-Louis Laborie, West Chester, OH (US); Steven Edward Nolte, West Chester, OH (US); Erhan Turan, Istanbul (TR)

(21) Appl. No.: 14/986,101

(22) Filed: Dec. 31, 2015

(51) Int. Cl. F02C 7/18; F01D 25/24; F01D 21/00; F02C 3/04

(52) U.S. Cl. CPC F02C 7/18; F02C 3/04; F01D 25/24; F01D 21/003; F05D 2220/32; F05D 2240/35; F05D 2270/303; F05D 2270/54; F05D 2270/62; F05D 2270/80

(57) ABSTRACT

A system for cooling an equipment compartment of a gas turbine engine includes a cooling manifold for directing cooling air from outside of the equipment compartment to within the equipment compartment, a temperature sensor disposed within the equipment compartment, an electronically controlled cooling valve configured to control the volume of air flowing through said cooling manifold, and a control unit configured to receive electronic data information from the temperature sensor and transmit electronic data information to the electronically controlled cooling valve based on electronic information received from said temperature sensor.

### BACKGROUND

The field of the disclosure relates generally to gas turbine engines and, more particularly, to gas turbine engines equipped with a core compartment cooling system.

Gas turbine engines are known to include a core engine that is surrounded by an annular engine casing, and to also utilize a combustor and turbines generally disposed along an axial centerline of the annular engine casing. The region between the casing and the combustor and turbines is known as the core compartment. The core compartment typically includes a number of components and/or devices that have temperature limits that can affect their operation.

Many known core engines are equipped with a core compartment cooling (CCC) system that extracts cooling air from outside of the annular engine casing, and directs the cooling air into the core compartment to reduce high temperatures produced by operation of the combustor and turbines within the core engine. The CCC system typically includes a cooling manifold and a control that operates a two-position cooling valve within the manifold, and then vents the cooling air overboard after it passes through the core compartment. At least some of these known CCC systems have been known to operate the two-position cooling valve according to a detected altitude, an engine core speed, an ambient temperature condition, or other surrogate parameters for core compartment cooling need.

The direction of cooling air into the core compartment, however, decreases the aerodynamic fuel efficiency of the gas turbine engine in-flight. The conventional systems only assume the need for core compartment cooling based on external conditions, and therefore typically direct air through the cooling manifold more often than is actually necessary to cool the components within the core compartment. The unnecessary use of the CCC system results in an undesirable increase in fuel consumption. Additionally, seals between different components of the core engine can wear out over time, allowing additional hot air to leak into the core compartment and increase the temperature therein. Conventional cooling systems that only schedule the CCC system from external conditions are unable to address seal leakage.

### BRIEF DESCRIPTION

In one aspect, a system for cooling a equipment compartment of a gas turbine engine includes a cooling manifold for directing cooling air from outside of the equipment compartment to within the equipment compartment, a temperature sensor disposed within the equipment compartment, an electronically controlled cooling valve configured to control the volume of air flowing through said cooling manifold, and a control unit configured to receive electronic data information from the temperature sensor and transmit electronic data information to the electronically controlled cooling valve based on electronic information received from said temperature sensor.

In another aspect, a method for cooling an equipment compartment of a gas turbine engine is provided. The equipment compartment includes an electronically controlled cooling valve configured to control an amount of airflow into the equipment compartment from outside the equipment compartment. The method includes measuring a temperature within the equipment compartment, comparing the measured temperature against a predetermined temperature range, calculating whether the measured temperature one of greater than, less than, and the same as the predetermined temperature range, transmitting a valve control signal to the electronically controlled cooling valve based on the calculation, and controlling the amount of airflow through the electronically controlled cooling valve based on the transmitted valve control signal.

In yet another aspect, a gas turbine engine includes a core engine including an interior compartment and a core engine casing enclosing the interior compartment from a volume of flowing air outside of the core engine casing. The gas turbine engine further includes a cooling manifold having an inlet in the core engine casing. The cooling manifold provides air communication between the outside volume of flowing air and the interior compartment. A temperature sensor is disposed within the interior compartment, and an electronically controlled cooling valve is disposed along the cooling manifold. The electronically controlled cooling valve is configured to control a volume of air flowing through the cooling manifold from the outside volume of flowing air. A control unit is electronically coupled with the temperature sensor and the electronically controlled cooling valve. The control unit is configured to incrementally open and close the electronically controlled cooling valve based upon electronic data information received from the temperature sensor.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary gas turbine engine in accordance with an exemplary embodiment of the present disclosure.

FIG. 2 is a schematic illustration of a core compartment cooling system that can be utilized with the gas turbine engine depicted in FIG. 1.

FIG. 3 is a block diagram illustrating a feedback control system for the core compartment of FIG. 2.

FIG. 4 is a flow chart diagram of a valve logic process for the core compartment cooling system of FIG. 2.

FIG. 5 is a schematic illustration of an alternative core compartment cooling system that can be utilized with the gas turbine engine depicted in FIG. 1.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

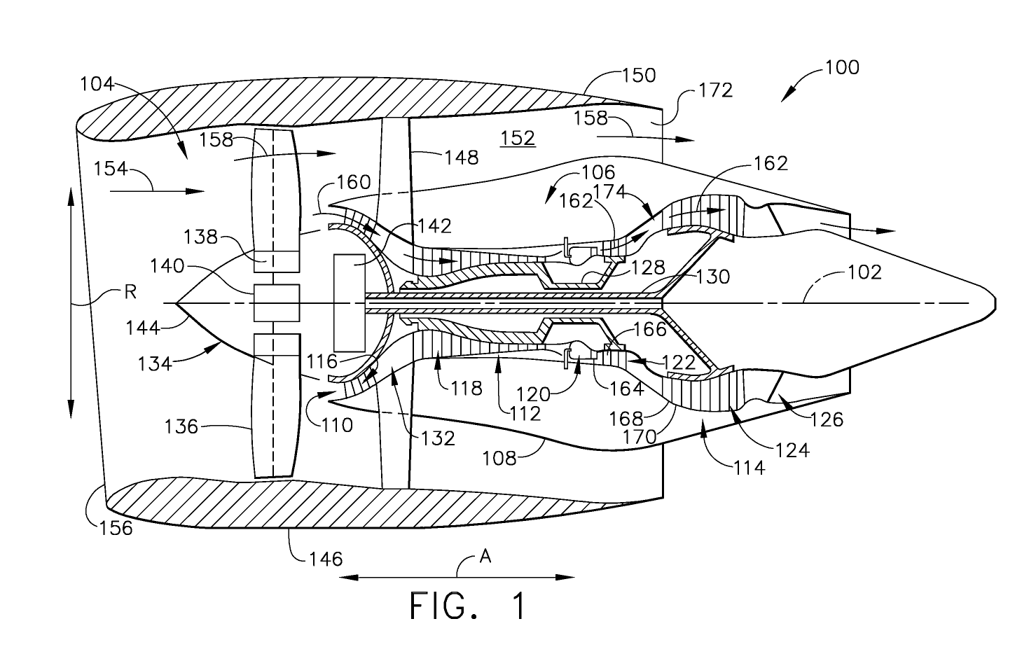

FIG. 1 is a schematic cross-sectional view of a gas turbine engine 100 in accordance with an exemplary embodiment of the present disclosure. In the exemplary embodiment, gas turbine engine 100 is embodied in a high-bypass turbofan jet engine. As shown in FIG. 1, gas turbine engine 100 defines an axial direction A (extending parallel to a longitudinal axis 102 provided for reference) and a radial direction R. In general, gas turbine engine 100 includes a fan section 104 and a core engine 106 disposed downstream from fan section 104.

In the exemplary embodiment, core engine 106 includes an approximately tubular outer casing 108 that defines an annular inlet 110. Outer casing 108 encases, in serial flow relationship, a compressor section 112 and a turbine section 114. Compressor section 112 includes, in serial flow relationship, a low pressure (LP) compressor, or booster, 116, a high pressure (HP) compressor 118, and a combustion section 120. Turbine section 114 includes, in serial flow relationship, a high pressure (HP) turbine 122, a low pressure (LP) turbine 124, and a jet exhaust nozzle section 126. A high pressure (HP) shaft, or spool, 128 drivingly connects HP turbine 122 to HP compressor 118. A low pressure (LP) shaft, or spool, 130 drivingly connects LP turbine 124 to LP compressor 116. Compressor section, combustion section 120, turbine section, and nozzle section 126 together define a core air flowpath 132.

In the exemplary embodiment, fan section 104 includes a variable pitch fan 134 having a plurality of fan blades 136 coupled to a disk 138 in a spaced apart relationship. Fan blades 136 extend radially outwardly from disk 138. Each fan blade 136 is rotatable relative to disk 138 about a pitch axis P by virtue of fan blades 136 being operatively coupled to a suitable pitch change mechanism (PCM) 140 configured to vary the pitch of fan blades 136. In other embodiments, pitch change mechanism (PCM) 140 is configured to collectively vary the pitch of fan blades 136 in unison. Fan blades 136, disk 138, and pitch change mechanism 140 are together rotatable about longitudinal axis 102 by LP shaft 130 across a power gear box 142. Power gear box 142 includes a plurality of gears (not shown) for adjusting the rotational speed of variable pitch fan 134 relative to LP shaft 130 to a more efficient rotational fan speed.

Disk 138 is covered by a rotatable front hub 144 that is aerodynamically contoured to promote airflow through fan blades 136. Additionally, fan section 104 includes an annular fan casing, or outer nacelle, 146 that circumferentially surrounds variable pitch fan 134 and/or at least a portion of core engine 106. In the exemplary embodiment, annular fan casing 146 is configured to be supported relative to core engine 106 by a plurality of circumferentially-spaced outlet guide vanes 148. Additionally, a downstream section 150 of annular fan casing 146 may extend over an outer portion of core engine 106 so as to define a bypass airflow passage 152 therebetween.

During operation of gas turbine engine 100, a volume of air 154 enters gas turbine engine 100 through an associated inlet 156 of annular fan casing 146 and/or fan section 104. As volume of air 154 passes across fan blades 136, a first portion 158 of volume of air 154 is directed or routed into bypass airflow passage 152 and a second portion 160 of volume of air 154 is directed or routed into core air flowpath 132, or more specifically into LP compressor 116. A ratio between first portion 158 and second portion 160 is commonly referred to as a bypass ratio. The pressure of second portion 160 is then increased as it is routed through high pressure (HP) compressor 118 and into combustion section 120, where it is mixed with fuel and burned to provide combustion gases 162.

Combustion gases 162 are routed through HP turbine 122 where a portion of thermal and/or kinetic energy from combustion gases 162 is extracted via sequential stages of HP turbine stator vanes 164 that are coupled to outer casing 108 and a plurality of HP turbine rotor blades 166 that are coupled to HP shaft 128, thus causing HP shaft 128 to rotate, which then drives a rotation of HP compressor 118. Combustion gases 162 are then routed through LP turbine 124 where a second portion of thermal and kinetic energy is extracted from combustion gases 162 via sequential stages of a plurality of LP turbine stator vanes 168 that are coupled to outer casing 108, and a plurality of LP turbine rotor blades 170 that are coupled to LP shaft 130 and which drive a rotation of LP shaft 130 and LP compressor 116 and/or rotation of variable pitch fan 134.

Combustion gases 162 are subsequently routed through jet exhaust nozzle section 126 of core engine 106 to provide propulsive thrust. Simultaneously, the pressure of first portion 158 is substantially increased as first portion 158 is routed through bypass airflow passage 152 before it is exhausted from a fan nozzle exhaust section 172 of gas turbine engine 100, also providing propulsive thrust. HP turbine 122, LP turbine 124, and jet exhaust nozzle section 126 at least partially define a hot gas path 174 for routing combustion gases 162 through core engine 106.

Gas turbine engine 100 is depicted in FIG. 1 by way of example only. In other exemplary embodiments, gas turbine engine 100 may have any other suitable configuration including for example, a turboprop engine.

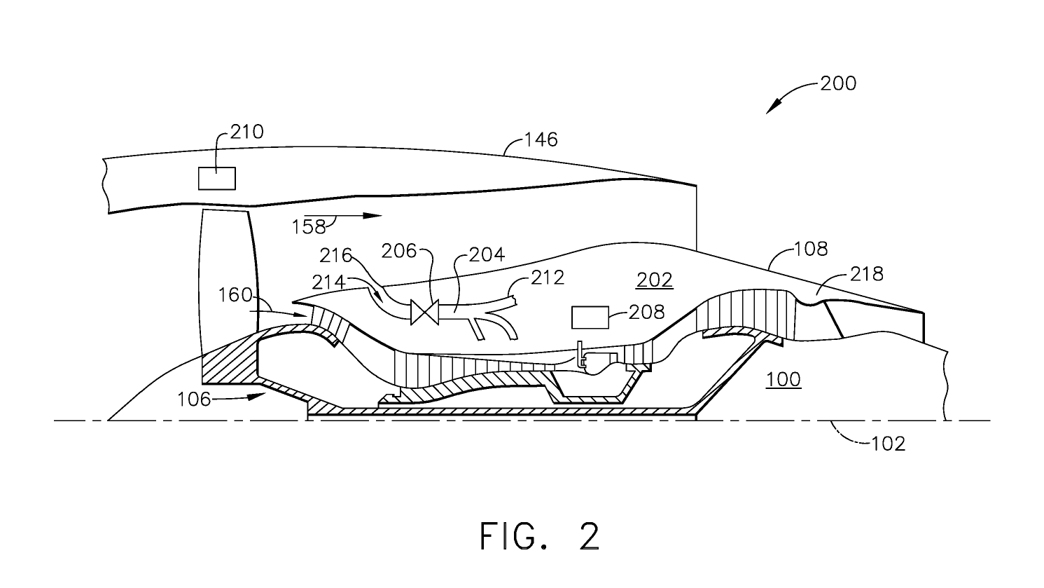

FIG. 2 is a schematic illustration of a core compartment cooling system (CCC) 200 that can be utilized with the gas turbine engine depicted in FIG. 1, as well as other gas turbine engines including a core engine. The core compartment is also sometimes referred to as the equipment compartment. The use of the same reference symbols in different drawings indicates similar or identical exemplary elements for purposes of illustration.

Referring to FIG. 2, core engine 106 includes a core compartment 202 between outer casing 108 and compressor section 112/turbine section 114. CCC system 200 includes a cooling manifold 204, a modulating valve 206, a temperature sensor 208, and a controller 210. In an exemplary embodiment, cooling manifold 204 includes a plurality of manifold ducts 212, and controller 210 is an electronic control unit configured to be capable of electronic data communication with modulating valve 206 and temperature sensor 208. In the exemplary embodiment, temperature sensor 208 is a thermocouple device.

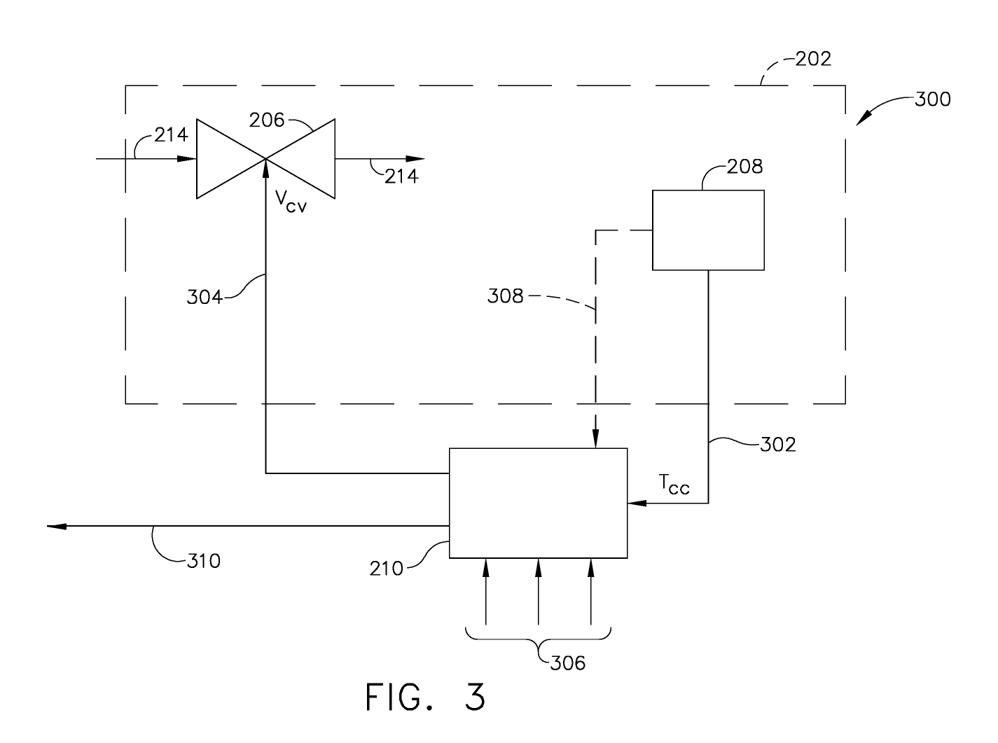

In operation, controller 210 transmits a signal (described further below with respect to FIG. 3) to modulating valve 206 to open sufficiently to allow a cooling portion 214 of air second portion 158 to be directed through an inlet 216 of cooling manifold 204 into core compartment 202. Cooling portion 214 is then distributed through manifold ducts 212 within core compartment 202 to separate regions (not numbered) or particular ones of the various controls and accessories within core compartment 202. Cooling portion 214 is then discharged overboard at an aft end 218 of core compartment 202.

Modulating valve 206 is configured to provide variable-flow capability CCC system 200 such that cooling portion 214 will have zero or near zero (i.e., modulating valve 206 fully closed), slow, moderate, or full stream (i.e., modulating valve 206 fully open) flow through cooling manifold 204, depending on the control signal sent from controller 210. The control signal is dependent, at least in part, on temperature data measured by temperature sensor 208 and transmitted to controller 210. Temperature sensor 208 and controller 210 thereby create a continual feedback loop (shown in FIG. 3) such that the actual volume of air cooling portion 214 directed through cooling manifold 204 is based on the actual temperature of air within core compartment 202, and not purely on external factors such as airspeed or ambient temperature, which can, at most, provide only a predictive assumption of the temperature experienced within core compartment 202. In an exemplary embodiment, the fully closed position of modulating valve 206 is configured to provide a minimum ventilation flow necessary to purge core compartment 202 of potentially flammable vapors. In an alternative embodiment, modulating valve 206 is a butterfly structure fabricated such that the butterfly valve portion (not shown) is slightly smaller than the valve bore (also not shown) to provide a thin annulus for air to flow when the butterfly valve is fully closed.

FIG. 3 is a block diagram illustrating a feedback control system 300 for core compartment 202 (shown in FIG. 2). Feedback control system 300 includes a first communication link 302 that is configured to allow electronic communication between temperature sensor 208 and controller 210. Temperature sensor 208 is configured to detect and measure a temperature within core compartment 202 and transmit the measured core compartment temperature information as an output data signal T_{CC} to controller 210 over first communication link 302. Feedback control system 300 includes a second communication link 304 that is configured to allow electronic communication between controller 210 and modulating valve 206. In an exemplary embodiment, first and second communication links 302, 304 directly couple the respective components by temperature-resistant hard wiring. In an alternative embodiment, first and second communication links 302, 304 are wireless data transmissions between respective communication ports (not shown).

In operation, feedback control system 300 is configured such that controller 210 continually samples output data signal T_{CC} at regular intervals. In an exemplary embodiment, controller 210 includes a processor (not shown) that processes output data signal T_{CC} to produce a valve control signal V_{CV} that is transmitted over second communication link 304 to modulating valve 206. Valve control signal V_{CV} will cause an actuator (not shown) of modulating valve 206 to open modulating valve 206 to allow a greater volume of cooling portion 214 to flow into core compartment 202, to close modulating valve 206 to inhibit the volume of cooling portion 214 through modulating valve 206, or to remain in position from the most recent previous valve control signal V_{CV} received by modulating valve 206 over second communication link 304. The volume of cooling air 214 flowing into core compartment 202 will affect the temperature in core compartment 202 that is continually measured by temperature sensor 208, and this cycle can continue repeatedly while core engine 106 is in operation.

More specifically, in an exemplary embodiment, controller 210 is configured to compare received sample data signal T_{CC} with a predetermined temperature range stored within controller 210, and then transmit valve control signal V_{CV} to modulating valve 206 such that the magnitude and vector of valve control signal V_{CV} is based upon the difference between the predetermined temperature range and the received sample data signal T_{CC}. In this example, the predetermined temperature range represents an optimum, or possibly a peak, temperature level within core compartment 202 in which the components contained therein may operate reliably.

In the example where data signal T_{CC} is greater than the predetermined temperature range, valve control signal V_{CV} is set to a value related to the magnitude of the difference between T_{CC} and the predetermined temperature range. That is, if the temperature measured within the core is significantly greater than the predetermined temperature range, valve control signal V_{CV} is set to a value that would open modulating valve 206 to allow a greater volume of air 214 than would be permitted through modulating valve 206 if T_{CC} were only slightly greater than the predetermined temperature range.

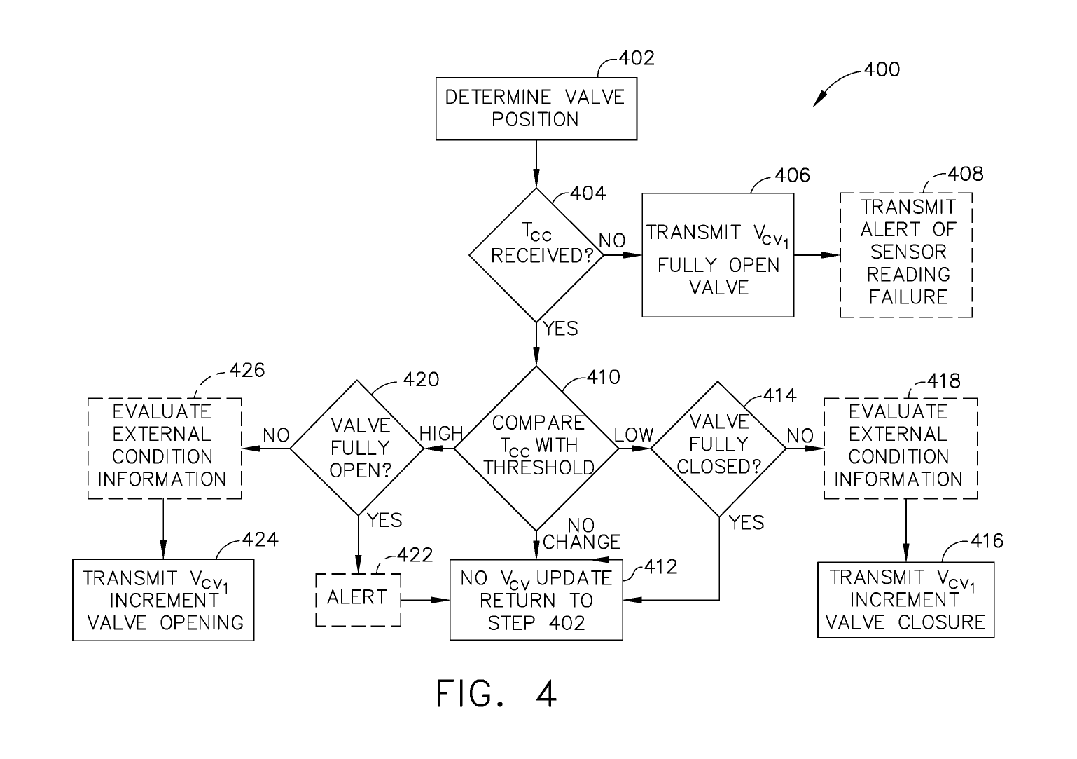

According to this exemplary embodiment, as the temperature detected by temperature sensor 208 within core compartment 202 increases above the predetermined temperature range, modulating valve 206 opens by a related amount to provide just enough of the air cooling portion 214 to flow through core compartment 202 such that the internal core temperature is reduced to the predetermined temperature range. In an alternative embodiment, valve control signal V_{CV} is set to a constant discrete value reflecting a set increment to open modulating valve 206, and feedback control system 300 repeats the process of detecting temperature T_{CC} and incrementing the opening of modulating valve 206 by valve control signal V_{CV} until either T_{CC} reaches the predetermined temperature range, or modulating valve 206 is fully open (described further below with respect to FIG. 4).

Similarly, according to the exemplary embodiment, as the core temperature detected by temperature sensor 208 decreases below the reference threshold, modulating valve 206 is configured to close sufficiently to inhibit or stop airflow cooling portion to flow through core compartment 202. Controller 210 is configured to transmit valve control signal V_{CV} to close modulating valve 206 by an amount related to the difference between the predetermined temperature range and the detected core compartment temperature T_{CC} below the predetermined temperature range.

Alternatively, valve control signal V_{CV} is set to a constant discrete incremental value, and feedback control system 300 repeats the process of detecting temperature T_{CC} and incrementally closing modulating valve 206 by valve control signal V_{CV} until either T_{CC} reaches the predetermined temperature range, or modulating valve 206 is fully closed.

Accordingly, by varying the flow of cooling portion 214, modulating valve 206 is capable of limiting the volume of air directed away from second portion 158 to only the amount needed to cool components within core compartment 202. By limiting this volume of air to only what is actually needed for cooling purposes, less air is directed away from the aerodynamic airflow of second portion 158, thereby improving fuel efficiency of gas turbine engine 100 during operation.

In a further alternative embodiment, controller 210 is configured to receive one or more additional external condition data information inputs 306 and utilize these data information inputs in determining the magnitude of valve control signal V_{CV}. External condition data information inputs 306 may include data regarding, for example, outside ambient temperature, altitude, fan speed, and other external ambient conditions. In an exemplary alternative embodiment, when gas turbine engine 100 is cruising at a high altitude, a high-speed, and/or a low ambient temperature, a lower air volume of cooling portion 214 is required to cool core compartment 202 than would be required during takeoff conditions. At takeoff, gas turbine engine 100 is more likely to encounter slower air speeds than while cruising. Additionally, gas turbine engine 100 is more likely to encounter higher ambient temperatures at cruising altitude than when near the ground, or engine idle. By implementing feedback control system 300, CCC system 200 is capable of continually modulating the volume of air cooling portion 214 into core compartment 202, even if the predictive value of external condition data information inputs 306, by themselves, is insufficient to cool core compartment 202.

In another alternative embodiment, controller 210 is further configured to receive a temperature condition data input 308 indicating whether temperature sensor 208 is operational. In the event that temperature sensor 208 is rendered nonfunctional during operation, or if first communication link 302 is unable to transmit data between temperature sensor 208 and controller 210, controller 210 is configured to transmit valve control signal V_{CV} to modulating valve 206 at a magnitude sufficient to render modulating valve 206 fully open. In this example, it is presumed that sacrificing some fuel efficiency is preferable to a risk of overheating significant components contained within core compartment 202. In this alternative embodiment, controller 210 is configured to transmit valve control signal V_{CV} to render modulating valve 206 fully open at engine idle conditions, for example.

In a further exemplary embodiment, controller 210 is configured to monitor sample data signal T_{CC} over time, and calculate a determination of a rapid rise magnitude of data signal T_{CC} over a relatively short period of time, which can indicate a sudden leak of hot gases into core compartment 202. Upon determination of a sudden, rapid rise in temperature of core compartment 202, controller 210 is further configured to transmit an alert output 310 indicating this condition. Alert output 310 is then electronically communicated, by direct wiring or wireless data transmission, to an instrument panel (not shown) of an aircraft utilizing gas turbine engine 100, and/or to a maintenance crew servicing gas turbine engine 100.

FIG. 4 is a flow chart diagram of a valve logic process 400 for core compartment cooling system of FIG. 2. Process 400 begins at step 402. In step 402, controller 210 determines the open position, i.e., fully open, fully closed, or somewhere in between, of the actuator (not shown) of modulating valve 206. In an exemplary embodiment, second communication link 304 is configured to provide two-way communication between controller 210 and modulating valve 206. Once the open position status of modulating valve 206 is determined, process 400 proceeds to step 404.

Step 404 is a decision step. In step 404, controller 210 determines whether controller 210 is receiving output data signal T_{CC} from temperature sensor 208 over first communication link 302. If output data signal T_{CC} is not received, process 400 proceeds to step 406. In step 406, controller 210 transmits valve control signal V_{CV} to modulating valve 206 at a value sufficient to render modulating valve 206 in a fully open position. A failure to detect output data signal T_{CC} may indicate a malfunction of temperature sensor 208 or first communication link 302, or possibly only a temporary interruption of data communication between temperature sensor 208 and controller 210.

In an exemplary embodiment, step 406 is executed after a predetermined time duration has elapsed without receiving output data signal T_{CC} from temperature sensor 208. By adding the time delay to the execution of step 406, process 400 is capable of avoiding a situation where modulating valve 206 is rendered fully open due to only a temporary interruption in data communication, thereby avoiding an unnecessary loss in fuel efficiency where additional cooling is not actually needed. Once step 406 is executed, process 400 returns to step 402. In an alternative embodiment, prior to returning to step 402, process 400 proceeds from step 406 to optional step 408. In step 408, controller 210 transmits an alert signal, e.g., to a cockpit warning light or a maintenance crew, indicating the failure to receive temperature information from temperature sensor 208.

Referring back to decision step 404, if output data signal T_{CC} is received, process 400 proceeds to step 410. Step 410 is also a decision step. In step 410, controller 210 compares output data signal T_{CC} with the predetermined temperature range, described above with respect to FIG. 3. If controller 210 calculates no difference, or an insignificant difference, between output data signal T_{CC} and the predetermined temperature range, process 400 proceeds to step 412. In step 412, no valve control signal V_{CV} is transmitted to modulating valve 206, and process 400 then returns to step 402.

If, however, in step 410, controller 210 calculates that output data signal T_{CC} is below the predetermined temperature range, i.e., indicating that core compartment 202 is sufficiently cooled, process 400 proceeds from step 410 to step 414. Step 414 is a decision step. In step 414, controller 210 determines whether modulating valve 206 is fully closed. If modulating valve 206 is fully closed, process 400 proceeds from step 414 to step 412, and thus back to step 402.

If, however, in step 414, controller 210 determines that modulating valve 206 is not fully closed, process 400 proceeds to step 416. In step 416, controller 210 transmits valve control signal V_{CV} to modulating valve 206 at a value sufficient to close modulating valve 206 by an amount related to the magnitude of output data signal T_{CC} below the predetermined temperature range. Process 400 and then returns to step 402. In an alternative embodiment, in step 416, controller 210 transmits valve control signal V_{CV} at a constant negative incremental value, and returns to step 402, where process 400 is repeated until modulating valve 206 is fully closed, or output data signal T_{CC} is no longer significantly below the predetermined temperature range.

In a further alternative embodiment, prior to proceeding to step 416, process 400 first proceeds from step 414 to optional step 418. In optional step 418, controller 210 will first evaluate data external condition data information inputs 306 regarding, for example, outside ambient temperature, altitude, fan speed, altitude, and other external ambient conditions, prior to calculating the appropriate magnitude of valve control signal V_{CV} that is transmitted to modulating valve 206 to close modulating valve 206 and thereby inhibit the air volume of cooling portion 214 allowed into core compartment 202. For example, during operation of a gas turbine engine 100 at relatively high altitudes and/or colder temperatures, data information from an external ambient temperature sensor, i.e., from data information inputs 306, will indicate that a lower volume of air for cooling portion 214 is necessary to provide the same amount of cooling to core compartment 202 than would be necessary at higher external temperatures and/or lower altitudes. That is, modulating valve 206 can be opened less, but still provide sufficient cooling air.

Referring back to step 410, if controller 210 calculates that output data signal T_{CC} is above the predetermined temperature range, i.e., indicating that core compartment 202 is not sufficiently cooled, process 400 proceeds from step 410 to step 420. Step 420 is a decision step. In step 420, controller 210 determines whether modulating valve 206 is fully open. If modulating valve 206 is fully open, process 400 proceeds from step 420 to step 412, and thus back to step 402. In an alternative embodiment, prior to proceeding to step 412, process 400 first proceeds from step 422 optional step 422. In step 422, controller 210 transmits an alert signal, e.g., to a cockpit indicator, that the temperature in core compartment 202 has exceeded the ability of CCC system 200 to cool core compartment 202 below the predetermined temperature range. This alternative embodiment, process 400 then proceeds from step 422 to step 412.

If, however, in step 420, controller 210 determines that modulating valve 206 is not fully opened, process 400 proceeds to step 424. In step 424, controller 210 transmits valve control signal V_{CV} to modulating valve 206 at a value sufficient to open modulating valve 206 by an amount related to the magnitude of output data signal T_{CC} above the predetermined temperature range. Process 400 and then returns to step 402. In an alternative embodiment, in step 424, controller 210 transmits valve control signal V_{CV} at a constant positive incremental value, and returns to step 402, where process 400 is repeated until modulating valve 206 is fully open, or output data signal T_{CC} is no longer significantly above the predetermined temperature range.

In a further alternative embodiment, prior to proceeding to step 424, process 400 first proceeds from step 420 to optional step 426. In optional step 426, controller 210 will first evaluate data external condition data information inputs 306 regarding external ambient conditions prior to calculating the appropriate magnitude of valve control signal V_{CV} that is transmitted to modulating valve 206 to open modulating valve 206. Similar to the example described above, if a lower volume of air for cooling portion 214 can be utilized to provide the same amount of cooling to core compartment 202, greater fuel efficiency can be realized, particularly at cruising operations.

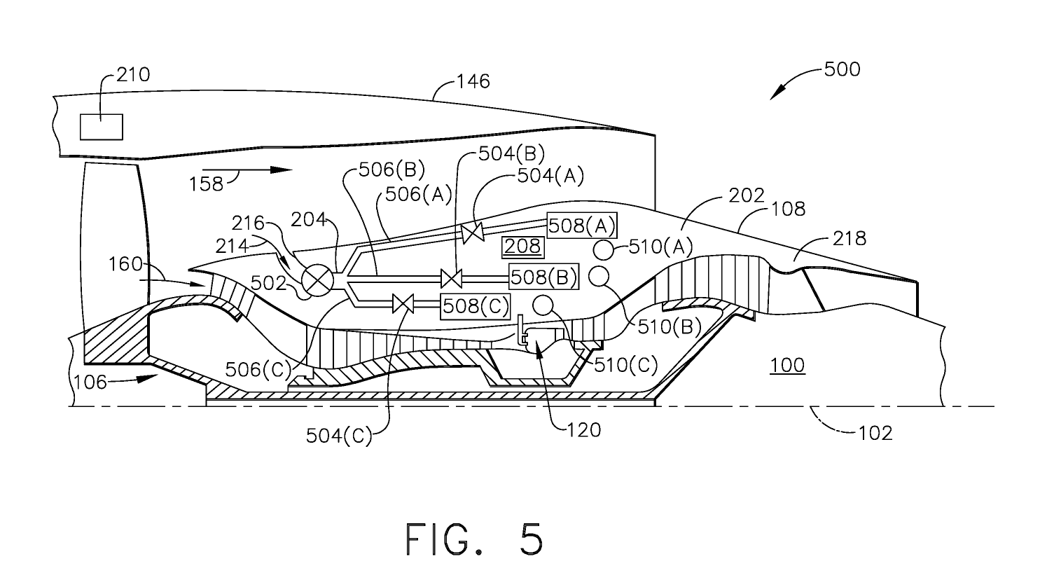

FIG. 5 is a schematic illustration of an alternative core compartment cooling (CCC) system 500 that can be utilized with gas turbine engine 100, shown in FIG. 1, as well as other gas turbine engines including a core engine. The use of same reference symbols in different drawings indicates similar or identical exemplary elements for purposes of illustration.

Referring to FIG. 5, according to this alternative embodiment, CCC system 500 includes a dual position valve 502 proximate inlet 216 of cooling manifold 204. In an exemplary embodiment, dual position valve 502 is a butterfly valve device that is either fully open or fully closed when actuated. CCC system 500 further includes a plurality of modulating valves 504(A), 504(B), 504(C) each disposed in a plurality of manifold ducts 506(A), 506(B), 506(C), respectively, of cooling manifold 204. Manifold ducts 506(A), 506(B), 506(C) direct cooling portion 214 to respective core components 508(A), 508(B), 508(C), respectively, disposed at different locations throughout core compartment 202. A plurality of temperature sensors 510(A), 510(B), 510(C) are disposed proximate core components 508(A), 508(B), 508(C), respectively. In an exemplary embodiment, temperature sensors 510 are thermocouple devices.

In operation, each modulating valve 504 in respective manifold duct 506 functions and is controlled similarly to modulating valve 206 in cooling manifold 204 as described above with respect to FIG. 2. In this alternative embodiment, however, modulating valve 206 in cooling manifold 204 is replaced by dual position valve 502. In an exemplary embodiment, dual position valve 502 remains open, and flow of cooling portion 214 into core compartment 202 is prevented by maintaining all modulating valves 504 in the fully closed position. When dual position valve 502 is open, each modulating valve 504 can independently operate the same as modulating valve 206 (shown in FIG. 2). For example modulating valve 504(A), will operate in a feedback control loop, as described with respect to FIG. 3, based on temperature information received at controller 210 from temperature sensor 510(A).

According to this alternative embodiment, different core components 508 can be individually monitored for temperature conditions within their immediate vicinity. In operation, temperature is not uniform throughout all regions of core compartment 202. For example, core components 508 nearest combustion section 120, e.g., core component 508(C), are more likely to be exposed to higher temperatures than would core components 508 nearest tubular outer casing 108, e.g., core component 508(A). The temperature measured near a particular core component 508 might exceed the predetermined temperature range even if a central temperature of core compartment 202, i.e., measured by temperature sensor 208, is below the predetermined temperature range. This temperature disparity could also be experienced by a particular core component 508 in the event of a seal leaking near the particular core component 508.

According to this alternative embodiment, the individual modulating valve 504 associated with a particular core component 508 can direct cooling portion 214 to the particular core component 508 without having to cool other regions of core compartment 202 that are experiencing temperatures below the predetermined temperature range. By further limiting the amount of air volume of cooling portion 214 directed into core compartment 202, this alternative embodiment is capable of realizing additional fuel consumption savings, particularly at cruising speeds.

Exemplary embodiments of core compartment cooling systems for gas turbine engines are described above in detail. The cooling systems, and methods of operating such systems and component devices are not limited to the specific embodiments described herein, but rather, components of the systems and/or steps of the methods may be utilized independently and separately from other components and/or steps described herein. For example, the methods may also be used in combination with other systems where hot air or other gases can flow across heat-sensitive components in a core engine, and are not limited to practice with only the systems and methods as described herein. Rather, the exemplary embodiment can be implemented and utilized in connection with many other machinery applications implement cooling systems utilizing redirection of cooling airflows.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for cooling an equipment compartment, said system comprising:
a cooling manifold for directing cooling air from outside of said equipment compartment to within said equipment compartment;
a temperature sensor disposed within said equipment compartment;
an electronically controlled cooling valve configured to control the volume of air flowing through said cooling manifold; and
a control unit configured to receive electronic data information from said temperature sensor and transmit the electronic data information to said electronically controlled cooling valve based on electronic information received from said temperature sensor.

2. The system as claimed in claim 1, wherein said temperature sensor comprises a thermocouple device.

3. The system as claimed in claim 1, wherein said electronically controlled cooling valve is a modulating valve configured to open at a plurality of settings.

4. The system as claimed in claim 3, wherein said cooling manifold comprises a plurality of manifold ducts configured to direct the cooling air to different respective regions of said equipment compartment.

5. The system as claimed in claim 4, wherein said electronically controlled cooling valve is disposed within said cooling manifold upstream of said plurality of manifold ducts.

6. The system as claimed in claim 4, wherein said electronically controlled cooling valve comprises a plurality of individual modulating valves, and wherein each modulating valve of said plurality of individual modulating valves is disposed within a different respective manifold duct of said plurality of manifold ducts.

7. The system as claimed in claim 6, wherein said temperature sensor comprises a plurality of individual temperature sensors, and wherein each temperature sensor of said plurality of individual temperature sensors is disposed proximate a different respective manifold duct of said plurality of manifold ducts.

8. The system as claimed in claim 6, further comprising a dual position valve disposed within said cooling manifold upstream of said plurality of manifold ducts.

9. The system as claimed in claim 3, wherein said control unit is further configured to receive electronic data information from said electronically controlled cooling valve.

10. The system as claimed in claim 9, wherein said control unit is further configured to detect an amount said modulating valve is open.

11. The system as claimed in claim 10, wherein said control unit is further configured to incrementally open or close said modulating valve between a fully open position and a fully closed position.

12. The system as claimed in claim 1, wherein said control unit is configured to send and receive electronic data information by direct electrical coupling with both of said temperature sensor and said electronically controlled cooling valve.

13. The system as claimed in claim 1, wherein said control unit is configured to send and receive electronic data information by wireless data transmission between said temperature sensor and said electronically controlled cooling valve, respectively.

14. The system as claimed in claim 1, wherein said control unit is further configured to receive electronic data information regarding external environmental conditions and control said electronically controlled cooling valve based at least in part on the received external environmental condition data information.

15. The system as claimed in claim 1, wherein said control unit is further configured to send an alert regarding one of a status of said temperature sensor and a measured temperature within said equipment compartment.

16. A method of cooling an equipment compartment of a gas turbine engine, said equipment compartment including an electronically controlled cooling valve configured to control an amount of airflow into said equipment compartment from outside the equipment compartment, the method comprising:
measuring a temperature within the equipment compartment;
comparing the measured temperature to a predetermined temperature range;
transmitting a valve control signal to the electronically controlled cooling valve based on the comparison; and
controlling the amount of airflow through the electronically controlled cooling valve based on the transmitted valve control signal.

17. The method as claimed in claim 16, wherein the electronically controlled cooling valve is a modulating valve configured to open at a plurality of settings ranging from fully open to fully closed.

18. The method as claimed in claim 17, further comprising detecting an open setting of the modulating valve.

19. The method as claimed in claim 18, further comprising sending an alert signal when the modulating valve is detected to be fully open and the measured temperature is greater than the predetermined temperature range.

20. A gas turbine engine comprising:
a core engine including an interior compartment and a core engine casing enclosing said interior compartment from a volume of flowing air outside of said core engine casing;
a cooling manifold including an inlet in said core engine casing, said cooling manifold configured to provide air communication between the outside volume of flowing air and said interior compartment;
a temperature sensor disposed within said interior compartment;
an electronically controlled cooling valve disposed along said cooling manifold, said electronically controlled cooling valve configured to control a volume of air flowing through said cooling manifold from the outside volume of flowing air; and
a control unit electronically coupled with said temperature sensor and said electronically controlled cooling valve, said control unit configured to incrementally open and close said electronically controlled cooling valve based upon electronic data information received from said temperature sensor.
